(19) United States
(12) Patent Application Publication
(10) Pub. No.: US 2005/0249250 A1
(43) Pub. Date: Nov. 10, 2005

(54) Laser diode monitoring system

(75) Inventors: Song-Feng Tsai, Taipei (TW); Kuo-Pei Weng, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/121,996

(22) Filed: May 5, 2005

(30) Foreign Application Priority Data
May 7, 2004 (TW) 93113011

(51) Int. Cl. H01S 3/13; H01S 3/00

(52) U.S. Cl. 372/29.011; 372/38.01; 372/29.021

(57) ABSTRACT

A laser diode monitoring system, including a thermistor, a monitoring unit, and a laser diode is disclosed. Thermistor is to receive a temperature for outputting an electrical temperature signal. The monitoring unit is coupled to the thermistor, and for receiving the electrical temperature signal to output a control signal. Laser diode, coupled to the monitoring unit, is for receiving the control signal to output a laser beam, wherein the temperature is determined based on the output power of the laser beam.

This application claims the benefit of Taiwan application Serial No. 09311301 1, filed May 7, 2004, the subject matter of which is incorporated herein by reference.

### BACKGROUND OF THE INVENTION

1. Field of the Invention

The invention relates in general to a laser diode output power monitoring system, and more particularly to a laser diode monitoring system for monitoring temperatures of a laser beam outputted by a laser diode.

2. Description of the Related Art

In a technologically advanced world today, most multimedia products are published in the form of optical discs. Over the years, optical discs designed for consumer use have tremendously increased on the market. Nowadays, almost every personal computer comes equipped with an optical disc drive. In fact, optical discs have become increasingly important in the field of multimedia applications.

The theory behind optical disc drive operation involves utilizing the laser diode of the optical pick-up head to output a laser beam. Then, the laser beam is projected onto the optical disc surface, forming a light spot of similar size to the data blocks of the optical disc. The optical disc drive then utilizes the magnitude of the light spot reflected off the data blocks as a basis for reading signals on the optical disc.

The laser diode in the optical pick-up head is often subject to contamination such as oil, dust, and high temperature, resulting in the attenuation of the laser beam output power. Thus, an optical disc drive is often equipped with a monitoring system, for monitoring the output power of the laser beam emitted by the laser diode. The monitoring system is used to detect the output power of the laser beam, and allows the output power gain of the laser beam to be fed back to the control chip, thereby adjusting the output power of the laser beam.

FIG. 1 shows illustration of the closed-loop control of the output power of the laser diode disposed in the optical disc drive. First, digital analog converter (DAC) 10 receives a digital control signal 12, for converting digital control signal 12 to an analog control signal 14. Analog feedback signal 42 is then subtracted from analog control signal 14 to generate a discrepancy signal 16, and is in turn outputted to compensator 20. Compensator 20 then generates a driver signal 22 based on discrepancy signal 16, and sends the driver signal 22 to amplifier 25. By such, amplifier 25 then can amplify driver signal 22 to yield a driver current 28, and send driver current 28 to laser diode (LD) 30, in which laser beam 32 is emitted by LD 30 based on driver current 28. After laser beam 32 is received by front monitor diode (FMD) 40, FMD 40 will output feedback signal 42.

Since the output power of the laser diode in the optical disc drive is subject to closed-loop control, the compensator can alter the driver signal in accordance with the magnitude of the discrepancy signal, such that the laser diode can output a stable output power as designated by the digital control signal.

As shown from above, conventional laser diode output power monitoring system 100 is to monitor the output power of the laser beam 32 generated by laser diode 30 using FMD 40. The purpose of FMD 40 is to ensure that the output power of the laser beam 32 generated by laser diode 30 accurately coincides with the value designed.

However, the drawback with the conventional optical pick-up head is that FMD 40 often comes with an expensive price, thus relatively, the manufacturing costs of optical pick-up heads and optical disc drives can not be effectively reduced.

### SUMMARY OF THE INVENTION

It is therefore an object of the invention to provide a laser diode monitoring system, allowing the manufacturing costs of the optical pick-up head of optical disc drives to be effectively reduced.

The invention achieves the above-identified object by providing a method of laser diode output power monitoring system, including a thermistor, a monitoring unit, and a laser diode. Thermistor is to receive a temperature for outputting an electrical temperature signal. Monitoring unit is coupled to the thermistor, and receives the electrical temperature signal for outputting a control signal. Laser diode is coupled to the monitoring unit, and receives the control signal for outputting a laser beam. Preferably, the temperature received by the thermistor is determined based on the output power of the laser beam.

In the above described laser diode monitoring system of the present invention, the monitoring unit can be a control chip for controlling the output power of the laser beam. Also, the laser diode monitoring system can be for applying to an optical disc drive.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG.1 shows illustration of a closed-loop control of an output power of the laser diode disposed in the optical disc drive.

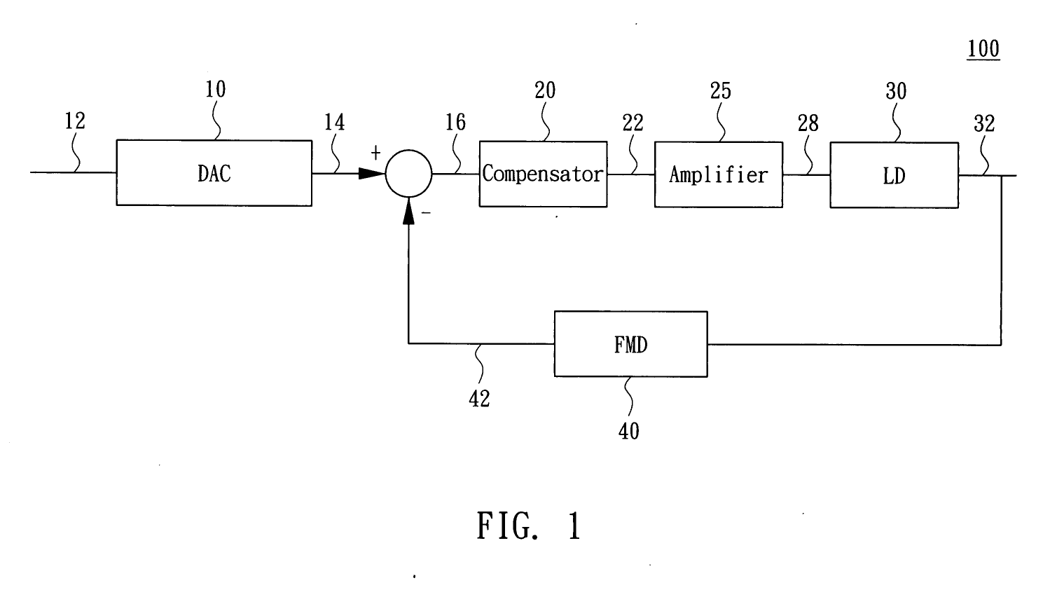

FIG. 2 shows illustration of a laser diode output power monitoring system according to a preferred embodiment of the invention.

### DETAILED DESCRIPTION OF THE INVENTION

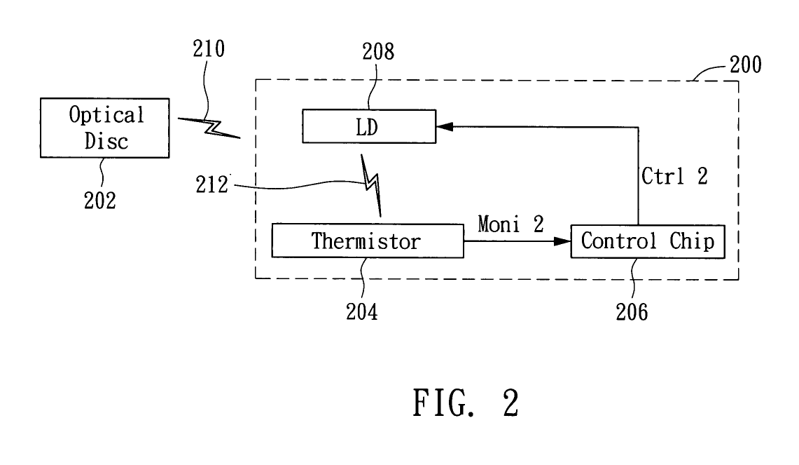

FIG. 2 shows illustration of a laser diode output power monitoring system according to an embodiment of the invention. The laser diode output power monitoring system 200 can be applied for reading an optical disc 202 of an optical disc drive. As shown in the figure, the laser diode output power monitoring system 200 includes a thermistor 204, a monitoring unit, and a laser diode (LD) 208. The above mentioned monitoring unit can be a control chip 206.

Thermistor 204 and LD 208 are both disposed in the optical pick-up head of the optical disc drive, and thermistor 204, in addition, is disposed near LD 208. Control chip 206 is disposed on the circuit board of optical disc drive. Control chip 206 is respectively connected to thermistor 204 and LD 208.

Indicated by the figure, laser beam 210 outputted by LD 208 is projected onto the surface of optical disc 202, which is used as a basis by the optical pick-up head for reading signals. Since thermistor 204 is to receive the detected heat (i.e. temperature) and convert the detected heat into electrical signals, the thermistor 204 neighboring LD 208 is to receive temperature 212. Temperature 212 is the combination of the temperature generated by laser beam 210 outputted by the laser diode, and the temperature distributed in temperature fields nearing laser beam 210.

Thermistor 204 then in turn converts the received temperature 212 into an electrical temperature signal Moni 2 for sending to control chip 206. Control chip 206 includes elements such as an A/D converter, a compensator, and an amplifier, and also includes a temperature-power mapping table. Since temperature 212 is positively related to the output power of the laser beam 210 generated by LD 208, temperature 212 is thus determined based on the output power of laser beam 210 generated by LD 208. Furthermore, the control chip readily obtain the output power of the laser beam 210 outputted by LD 208 by looking up the temperature-power mapping table, based on electrical temperature signal Moni 2 outputted by thermistor 204. Then, through elements such as the A/D converter, the compensator, and the amplifier that are inside the control chip, control signal Ctrl 2 is outputted to laser diode 208. By doing so, control chip 206 controls LD 208 via control signal Ctrl 2, allowing LD 208 to output laser beam 210 of corrected output power.

As shown from above, the laser diode output power monitoring system 200 according to the embodiment of the invention is to input the electrical temperature signal detected by thermistor 204 to control chip 206, for looking up the temperature-power mapping table built in the control chip 206 to thereby obtain the output power of laser beam 210. Through elements internal to the control chip, such as the compensator and the amplifier, the output power of the laser beam 210 by LD 208 can therefore accurately coincide with the designed value. That is, regardless of causes such as dust and high temperature, the output power of laser beam 210 can remain constant and un-attenuated.

Conclusively, one of the advantages of the invention is being in the replacement of the conventional use of expensive FMDs with less expensive thermistor counterparts. Thus, by utilizing the positive relation between the laser diode surrounding temperature and the output power, in conjunction with the thermistor and the utilization of the temperature-power mapping table built in the control chip, the embodiment of the invention allows the output power of the laser diode to be controlled within a precise range. Moreover, since the adopted themistors are relatively less expensive than FMDs, the costs associated in manufacturing optical pick-up head and optical disc drive can be effectively reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A laser diode output power monitoring system, comprising:
a thermistor, receiving a temperature, for outputting an electrical temperature signal;
a monitoring unit, coupled to the thermistor, for receiving the electrical temperature signal to output a control signal; and
a laser diode, coupled to the monitoring unit, for receiving the control signal to output a laser beam, wherein the temperature is determined based on the output power of the laser beam.

2. The laser diode output power monitoring system according to claim 1, wherein the monitoring unit is a control chip for controlling the output power of the laser beam.

3. The laser diode output power monitoring system according to claim 1 is applied in an optical disc drive.

4. An optical pick-up head monitoring system, applied in an optical disc drive, the optical disc drive being used for reading an optical disc, the optical pick-up head monitoring system comprising:
a thermistor, receiving a temperature, for outputting an electrical temperature signal;
a monitoring unit, coupled to the thermistor, for receiving the electrical temperature signal to output a control signal; and
an optical pick-up head, having a laser diode coupled to the monitoring unit, the laser diode being used for receiving the control signal to output a laser beam, wherein the temperature is determined based on the output power of the laser beam.

5. The optical pick-up head monitoring system according to claim 4, wherein the monitoring unit is a control chip for controlling the output power of the laser beam.

6. A method of monitoring a laser diode output power, comprising,
receiving a temperature from the laser diode;
converting the temperature to a electrical temperature signal; and
outputting a control signal to drive the laser diode based on the electrical temperature signal according to a temperature-power mapping table.
